(19) United States
(12) Patent Application Publication
(10) Pub. No.: US 2020/0001656 A1
(43) Pub. Date: Jan. 2, 2020

(54) LATERAL DISCONTINUITIES HAVING THICKNESSES INCREASING FROM SHOULDER TO CENTER OF TIRE TREAD

(71) Applicants: John Limroth, Simpsonville, SC (US); Mark Collett, Simpsonville, SC (US)

(72) Inventors: John Limroth, Simpsonville, SC (US); Mark Collett, Simpsonville, SC (US)

(73) Assignee: Compagnie Générale des Établissements Michelin, Clermont-Ferrand (FR)

(21) Appl. No.: 16/465,413

(22) PCT Filed: Nov. 30, 2017
(86) PCT No.: PCT/US2017/063997

§ 371 Date: May 30, 2019

(30) Foreign Application Priority Data
Nov. 30, 2016 (US) PCT/US2016/064268

(51) Int. Cl. B60C 11/12; B60C 11/03; B60C 11/11

(52) U.S. Cl. CPC B60C 11/1218; B60C 11/0302; B60C 11/0306; B60C 11/11; B60C 2011/1286; B60C 2011/0365; B60C 2011/1209; B60C 2011/1277; B60C 11/1281

(57) ABSTRACT

Embodiments include a tire tread having a plurality of tread elements and a plurality of lateral discontinuities arranged along the tread width and tread length, each of the plurality of tread elements being spaced apart by one of the plurality of lateral discontinuities. The tread width is divided into a plurality of regions, the plurality of regions including: (1) a pair of outermost regions, each outermost region being arranged closest to one of the pair of opposing lateral sides of the tread, and (2) at least one centermost region is arranged closest to the longitudinal centerline of the tread. Each of the lateral discontinuities have a thickness, where the thickness of one or more of the lateral discontinuities arranged in each of the outermost regions is smaller than the thickness of one or more of the lateral discontinuities arranged in the centermost region.

### CROSS-REFERENCE TO RELATED APPLICATION

This application claims priority to, and the benefit of, International Patent Application No. PCT/US2016/064268, filed Nov. 30, 2016 with the U.S. Patent Office (in the capacity of a Receiving Office), and which is hereby incorporated by reference.

### BACKGROUND

### Field

This disclosure relates generally to tire treads, and more particularly, to tire treads having a plurality of tread elements with lateral discontinuities arranged there between.

### Description of the Related Art

Tread wear mostly occurs when the portion of tread in contact with a ground surface exits this contact during tire rolling operation. This wear occurs as a result of slip occurring between the tread and the ground surface as the tread exits contact, which arises due to two phenomena acting concurrently. Particularly, this slip occurs due to the combination of maximum shear strain and a reduction of radial pressure to zero occurring at the trailing edge of tire contact, as the tread exits contact with the ground surface.

The wear profile of any tire generally relates the wear amongst all the ribs arranged across the width of the tire tread, where a rib is an arrangement of one or more tread elements extending the full length of the tire tread, and when installed on the tire, each rib extends annularly around the tread. As for the wear profile, it is often desirous to maintain consistent wear across all ribs of the tread. Not only is the rib-to-rib wear impacted by the two phenomena discussed above, the variation in wear between ribs is also impacted by the different radii along which the various ribs extend, as the lateral profile of most tires is not flat but rather is rounded. In effect, for ribs of identical rigidity, a flatter lateral profile generates less variation in wear from rib-to-rib, while a rounder lateral profile generates more variation wear from rib-to-rib.

Common mechanisms for controlling the variation in wear across the different ribs of the tread include: (1) altering the tread element (block) lengths based upon rib location between a shoulder location and the center of the tread width, and (2) altering the length or radius of any rib based upon rib location between a shoulder location and the center of the tread width.

With regard to altering the length of tread elements, while this may provide certain improvements for certain driving conditions, tire performance in other conditions may be negatively impacted. As to altering the length or radius of any rib, while providing a flatter profile may improve wear consistency across the width of the tread from rib-to-rib, this flatter profile alters the shape of the tire footprint (the area of contact between the tire and the ground surface), which in turn provides a more rectangular footprint that can negatively impact other performance measures, such as noise, handling, and comfort, for example.

Therefore, there is a need to provide another mechanism for improving the wear consistency between ribs located across a tread width that does not necessarily generate reductions in other performance measures.

### SUMMARY

Embodiments include a tire tread comprising a tread length extending in a longitudinal direction, a tread width extending in a lateral direction, a tread thickness extending in a depthwise direction from an outer, ground-engaging side of the tread, each of the longitudinal direction, the lateral direction, and the depthwise direction being perpendicular to one another. The tread width extends between a pair of opposing sides of the tread each arranged at a widthwise extent of the outer, ground-engaging side, and a longitudinal centerline extending in the tread length in the longitudinal direction midway across the tread width. The tire tread further includes a plurality of tread elements and a plurality of lateral discontinuities arranged along the tread width and tread length, each of the plurality of tread elements being spaced apart by one of the plurality of lateral discontinuities. The tread width is divided into a plurality of regions, the plurality of regions including: (1) a pair of outermost regions, each outermost region being arranged closest to one of the pair of opposing lateral sides of the tread, and (2) at least one centermost region is arranged closest to the longitudinal centerline of the tread. Each of the lateral discontinuities have a thickness, the thickness being defined by opposing faces of the tire tread, each face extending laterally and depthwise into the tread thickness with each corresponding lateral discontinuity. For the plurality of lateral discontinuities, the thickness of one or more of the lateral discontinuities arranged in each region of the pair of outermost regions is smaller than the thickness of one or more of the lateral discontinuities arranged in the centermost region.

The foregoing and other objects, features and advantages of the invention will be apparent from the following more detailed descriptions of particular embodiments of the invention, as illustrated in the accompanying drawing wherein like reference numbers represent like parts of the invention.

### BRIEF DESCRIPTION OF THE DRAWINGS

FIG. 1A is a top view of a tire tread, and a segment of the tire tread, where the thickness of lateral discontinuities become greater when moving from shoulder ribs to the center rib.

FIG. 1B is a sectional view of the tread shown in FIG. 1A, showing the tread width and thickness.

FIG. 2 is a sectional side view of a lateral discontinuity arranged within a shoulder rib, taken along line 2-2 in FIG. 1A.

FIG. 3 is a sectional side view of a lateral discontinuity arranged within an intermediate rib, taken along line 3-3 in FIG. 1A.

FIG. 4 is a sectional side view of a lateral discontinuity arranged within a center rib, taken along line 4-4 in FIG. 1A.

FIG. 5 is a sectional side view of an alternative embodiment of the tire tread shown in FIGS. 2-4, showing a lateral discontinuity extending linearly into the tread depth biased to the direction of the tread thickness.

FIG. 6 is a sectional side view of an alternative embodiment of the tire tread shown in FIG. 5, showing a lateral discontinuity extending into the tread depth biased to the direction of the tread thickness and having a variable thickness.

FIG. 7 is a sectional side view of an alternative embodiment of the tire tread shown in FIG. 5, showing a lateral discontinuity extending along a non-linear path into the tread depth biased to the direction of the tread thickness.

FIG. 8 is a top view of an alternative embodiment to the tread shown in FIG. 2A, where a pair of central ribs are provided.

FIG. 9 is a top view of an alternative embodiment to the tread shown in FIG. 2A, where the tread is free of any ribs.

FIG. 10 is a variation of the embodiment shown in FIG. 1A, where lateral discontinuities in each shoulder region and rib form lateral grooves and lateral sipes.

FIG. 11 is a top view of a lateral discontinuity arranged between a pair of tread elements, where three voids are arranged along the length of the lateral discontinuity.

FIG. 12 is a side view of a lateral discontinuity arranged between a pair of tread elements, where a submerged void is arranged at the terminal end of the lateral discontinuity within the tread thickness.

### DETAILED DESCRIPTION OF PARTICULAR EMBODIMENTS

It is has been determined that by varying the thickness of any lateral discontinuity between different regions or ribs arranged at different widthwise locations across the tread, that is, by employing lateral discontinuities within a particular widthwise region or rib having a thickness different from lateral discontinuities arranged in other regions or ribs located at different lateral locations across the tread width, more consistent wear may be achieved across the tread width between the regions or ribs. Use of this new technique can be used together with any of the other techniques for managing the wear profile of a tire tread. It is especially appreciated that this new technique may be used as an alternative to the other techniques, thereby permitting improved wear profiles without sacrificing other performance measures that may arise when employing the other, prior art techniques. For example, by not flattening the lateral tread profile, the advantages of maintaining a rounder tread profile are enjoyed while still providing more consistent wear across the tire tread by using this new technique. Accordingly, this new technique may be used with any tread design to improve more consistent wear performance across the width of the tire tread.

A tire tread, as generally discussed herein, includes a tread length extending in a longitudinal direction, a tread width extending in a lateral direction, a tread thickness extending in a depthwise direction, each of the longitudinal direction, the lateral direction, and the depthwise direction being perpendicular to one another. The tread width extends between a pair of opposing sides of the tread. Each of the pair of sides are also referred to as a lateral side of the tread. Each of the pair of opposing sides is arranged at the widthwise extent of the outer, ground-engaging side of the tread, which extends along a lateral profile to each of opposing widthwise extents until reaching a portion of the tread that begins to extend down each opposing sidewall of the tire. Therefore, when referencing the width of the tread herein, unless specifically noted otherwise, the width of the tread connotes the widthwise extent of the outer, ground-engaging side and not the full widthwise extend of the tread material, which extends beyond the lateral profile of the outer, ground-engaging side and down the sidewalls of the tire. The tire tread also includes a widthwise centerline extending in the direction of the tread length, or, in other words, in the longitudinal direction of the tire tread, midway across the tread width between the pair of opposing sides.

The tire tread also includes a plurality of tread elements, which are also referred to as tread blocks. These tread elements are separated by a plurality of discontinuities, which may form any combination of grooves and sipes. Stated differently, each tread element is defined by any combination of one or more discontinuities and any lateral side edge of the tire tread. For example, an interior tread element spaced lateral inward from a lateral side of the tread may be bounded by four (4) discontinuities, such as a pair of spaced apart longitudinal grooves each extending in the longitudinal direction of the tread length and a pair of spaced apart lateral discontinuities extending at least partially in a direction of the tread width. By further example, a tread element arranged along a lateral side of the tire tread, which is referred to as a shoulder tread element, may be bounded by a lateral side edge of the tread, a longitudinal groove, and a pair of spaced apart lateral discontinuities. A lateral discontinuity, for any tread, may form a groove or sipe, where a sipe is a narrow groove or laceration.

It is appreciated that tread elements may be arranged in any manner along the tread, and may be submerged below the outer, ground-engaging side of the tread when at least partially formed by submerged discontinuities. In certain instances, the tread elements are arranged without using any longitudinal grooves extending in the longitudinal direction (that is, the direction of the tread length), such that plurality of tread elements are not arranged adjacently (side-by-side) in a longitudinal direction of the tread to form one or more ribs. In certain other instances, a plurality of tread elements are arranged adjacently (side-by-side) in a longitudinal direction of the tread to form one or more ribs and which are bounded by a longitudinal groove. Adjacent tread elements (of the plurality of adjacent tread elements) are separated by a lateral discontinuity. The plurality of tread elements forming a rib may be described as forming an array of tread elements along the length of the corresponding rib. A rib commonly extends a full length of the tread, but could, in certain instances, extend less than the full length of the tire tread. While one or more ribs may be provided, in particular instances, the tire tread includes a plurality of ribs extending in the longitudinal direction of the tire tread.

In any tire tread, whether or not having any ribs, a lateral discontinuity has a length extending at least partially in the lateral direction of the tire tread. When extending partially in the lateral direction, the length also extends partially in the longitudinal direction of the tread, whereby the length can be described as being biased relative to the lateral direction. When not extending partially in the lateral direction, the lateral discontinuity length extends in the lateral direction of the tread. The lateral discontinuity also has a depthwise extension extending into the tread thickness at least partially in the direction of the tread thickness away from the outer, ground-engaging side. The depthwise extension extends perpendicular to the lateral discontinuity length. When this depthwise extension extends partially in the direction of the tread thickness, the depthwise extension also extends partially in the longitudinal direction of the tread, where the depthwise extension can be described as being biased relative to the direction of the tread thickness. When not extending partially in the direction of the tread thickness, the depthwise extension of the lateral discontinuity extends in the direction of the tread thickness.

It is also noted that each lateral discontinuity has a thickness (also referred to as a width). The thickness extends in a direction perpendicular to the length and depthwise extension of the lateral discontinuity. In certain instances, a lateral discontinuity has a zero thickness, that is, when the lateral discontinuity forms a sipe comprising a laceration. Otherwise, when the lateral discontinuity has a non-zero thickness, it is either a sipe that forms a narrow groove or a lateral groove having a thickness greater than the width of the narrow groove otherwise forming a sipe. In certain instances, the sipe has a width such that the sipe is configured to articulate between an open configuration and a closed configuration as the tire rotates during tire operation. A sipe can be described as having a width equal to or less than 1.4 mm (millimeter) or equal to or less than 1.0 mm, and as low as zero (0 mm).

It is appreciated that the length of any lateral discontinuity may extend along any linear or non-linear path. Likewise, the depthwise extension for any lateral discontinuity may extend along any linear or non-linear path. Further, the thickness for any of the lateral discontinuity has a thickness extending perpendicular to both the depthwise extension and length of the lateral discontinuity. The thickness may be constant, or variable, as each lateral discontinuity extends along the depthwise extension and along the length of the lateral discontinuity.

It is appreciated that when the tire tread is in an unworn state, the lateral discontinuities may extend into the tread thickness from the outer, ground-engaging side of the tread or, when the lateral discontinuity is a submerged lateral discontinuity, extends into the tread thickness from below the outer, ground-engaging side of the tread. When submerged, the lateral discontinuity becomes exposed to the outer, ground-engaging side after a thickness of the tread arranged between the outer, ground-engaging side and the submerged lateral discontinuity is removed, such as due to wear, for example.

The tread width can be described as being divided into different widthwise regions. For example, in certain instances, the tread is parsed into having at least a pair of shoulder regions and a center region. Each of these regions extend across a portion of the tread width and along the length of the tread, that is, the full length of the tread. In certain instances, the width of these regions can be associated to the tread width by percentage. For example, in certain instances, each of the center and shoulder regions form ⅓^{rd} of the tread width. In other instances, the width of the center region is 15% to 30% of the tread width, while the width of each shoulder region is 35% to 42.5% of the tread width. In still other instances, the width of the shoulder region is 20% to 35% of the tread width, and the width of the center region is 30% to 60% the tread width. Optionally, an intermediate region may be arranged between any shoulder region and the center region, with the understanding that if an intermediate region is located between the center region and any shoulder region, a second intermediate region may or may not be arranged between the center region and the other shoulder region. It is appreciated that the width of any intermediate region can be equal to any percentage of the tread width, but in certain instances, could be equal to 2% to 5% of the of the tread width or 20% to 70% of the tread width, where these percentages contemplate the tire tread having one or two intermediate regions. It is also contemplated that in any of the prior instances, or in other instances, the shoulder region is 30% greater than the center region and/or each of the shoulder and center regions are equal to or greater than 20 mm.

When a tire tread includes a plurality of ribs, the plurality of ribs are spaced apart laterally, that is, in the direction of the tread width, where a longitudinal groove is arranged between adjacent ribs. A longitudinal groove extends primarily in the direction of the tread length, and may extend along a path that extends continuously in the direction of the tread length or may also extend partially in the lateral direction at any location along the longitudinal groove length as desired. The plurality of ribs includes a pair of outermost ribs, each rib of the pair of outermost ribs being arranged closest to one of the pair of opposing lateral sides of the tread of the plurality of ribs. These outermost ribs are each referred to as a shoulder rib. The plurality of ribs also includes at least one centermost rib being arranged closest to the longitudinal centerline of the tread of the plurality of ribs. It is appreciated that the tire tread may have a single central rib (centermost rib) or a plurality of central ribs (centermost ribs). For example, in certain instances, at least one centermost rib forms a single central rib arranged closest to the widthwise centerline. This single central rib may be arranged along the centerline. This single central rib may be arranged in any relation to the centerline, such as being centered or offset from the centerline, for example. By further example, at least one centermost rib may form a pair of central ribs arranged on laterally opposing sides of the centerline. It is appreciated that for the pair, one may be arranged along (coincident with) the centerline and the other spaced apart from the centerline by a short distance to remain close or near the centerline. In other instances, each of the pair is spaced apart from the centerline. Optionally, between one or each of the pair of outermost ribs and the one or more centermost rib is arranged one or more intermediate ribs. As it is apparent from the foregoing that various ribs may be present, it is appreciated that, for any combination of ribs contemplated above, the plurality of ribs arranged along a tire tread include at least three ribs (a pair of shoulder ribs and a center rib) but may include any additional quantity of ribs. Regardless as to whether the quantity of ribs is odd or even in number, it is appreciated that the arrangement of ribs may be symmetrical or asymmetrical about the widthwise centerline. It is appreciated that each rib may have any desired width, although in certain instances, the width of teach rib is at least 20 mm and/or each shoulder rib is between 20 and 40% greater than the corresponding center rib. It is also appreciated that, in certain embodiments, the pair of shoulder ribs, the center rib, and any optional intermediate ribs are arranged within a corresponding region discussed above, where any shoulder rib is arranged within the shoulder region, any center rib is arranged within the center region, and any intermediate rib present is arranged within an intermediate region. It is appreciated that any intermediate region may include one or more intermediate ribs, any center region may include one or more center ribs, and any shoulder region may include one or more shoulder ribs.

With reference again to the various regions arranged across the tread width, the thickness of at least one lateral discontinuity in each shoulder region is less than the thickness of at least one tread element located in any central region, and when any intermediate region is optionally present, the thickness of at least one tread element within any intermediate region is less than the thickness of the at least one tread element in the central region and greater than the thickness of the at least one tread element in each shoulder region. In particular instances, with regard to ribs, the thickness of at least one lateral discontinuity in each of the shoulder ribs is less than the thickness of at least one lateral discontinuity in each central rib, and when any intermediate ribs are optionally present, the thickness of at least one lateral discontinuity in an intermediate rib is less than the thickness of at least one lateral discontinuity in a central rib and greater than the thickness of the at least one lateral discontinuity in each shoulder rib. These relative associations between lateral discontinuity thicknesses may be made by comparing at least one or each lateral discontinuity in each of the regions or ribs, meaning, at least one or each lateral discontinuity in each region or rib has any relative thicknesses characterized as previously noted, or the thickness associations are made with regard to an average lateral discontinuity thickness determined for each region or rib, or any lengthwise portion of each, whether or not the prior tread element thickness characterizations are made with regard to these determined average thicknesses.

Determining the thickness of any lateral discontinuity may be accomplished in a variety of ways. In any manner, the thickness of any lateral discontinuity is measured in a direction perpendicular to the sipe length, or a centerline extending along the length of the path, and perpendicular to the direction of the tread thickness, or to the depthwise path along which the depthwise extension of the lateral discontinuity extends. This depthwise path extends the full depth of the lateral discontinuity at a location halfway between each of the opposing faces of the tread forming the thickness of the lateral discontinuity. In measuring the thickness of a lateral discontinuity, the thickness extends from one opposing face and across the thickness of the lateral discontinuity and to the other opposing face. It is appreciated that any one or more voids may be arranged along the length or depthwise extent of a lateral discontinuity, where any such void has a thickness greater than the thickness of the lateral discontinuity. Accordingly, it is stressed that the thickness measurement is not measured from any void arranged along any lateral discontinuity. Instead, the tread element thickness is measured from each opposing face associated with the lateral discontinuity. In other words, the thickness is measured from each face associated with the lateral discontinuity, and not along any void extending from any face along the lateral discontinuity. It is appreciated that, for any lateral discontinuity, the thickness of the lateral discontinuity may remain constant or vary across the width and/or depth of the lateral discontinuity.

In comparing between the thicknesses of lateral discontinuities arranged in a shoulder region (the “outermost region”), in a center region (the “centermost region”), and, when present, in an intermediate region, it is appreciated that any such thickness may form any thickness measured along the depthwise extension of the lateral discontinuity and taken at any location along the length of the lateral discontinuity, or the thickness may be an average thickness determined for each such lateral discontinuity. In other instances, an average lateral discontinuity thickness may be determined for each region, and the relative average lateral discontinuity thicknesses provided amongst the shoulder and center regions, and if present, each intermediate region.

For example, in certain instances, the thickness of a lateral discontinuity taken at any location along the depthwise extension thereof in a shoulder region is less than the thickness of a lateral discontinuity taken at any location along the depthwise extension thereof in a center region, and when present, the thickness of a lateral discontinuity taken at any location along the depthwise extension thereof in an intermediate region is less than the thickness of the lateral discontinuity in the center region and greater than the thickness of the lateral discontinuity in the shoulder region. In exemplary instances, the lateral discontinuity thickness in the shoulder region is 0.13 mm, the lateral discontinuity thickness in the intermediate region is 0.4 mm, and the lateral discontinuity thickness in the center region is 0.6 mm. In a more general example, the thickness of at least one lateral discontinuity in each shoulder region is 0 to 0.3 mm and the thickness of at least one lateral discontinuity in the center region is 0.3 to 0.8 mm or more in other variations. In another example, the thickness of at least one lateral discontinuity in each shoulder region is 0 to 0.2 mm, the thickness of at least one lateral discontinuity in the center region is 0.2 to 0.4 mm or 0.4 to 0.8 mm, and the thickness of at least one lateral discontinuity in any intermediate regions is 0.4 to 0.8 mm or more in other variations. It is appreciated that the relative association between lateral discontinuities in different regions and the thicknesses thereof may be made by relating lateral discontinuities located at the same or different longitudinal locations around the tire. In certain instances, the lateral discontinuities in different regions whose thicknesses are being related are located at the same longitudinal location of the tire tread, where at the longitudinal location, which extends across the tread width, a corresponding lateral discontinuity located in a shoulder and central region, and when present, in an intermediate region, are associated and characterized as having the relative thickness associations described herein. In lieu of requiring association based upon a specific longitudinal location, association between lateral discontinuity thicknesses within the different regions may occur within a specific range of longitudinal locations. In particular instances, this is accomplished within a segment of the tire tread. A segment of the tread can be described as a portion of the tire tread that extends for a specified length less than the full length of the tread, and while each segment may form a partial length of the tread, each segment extends the full width of the tread. Often, the tread pattern, that is, the arrangement of voids along the outer, ground-engaging side, repeats, where each segment forms a repeating portion of the tread pattern or more generally of the tread, although minor variations may occur between segments, such as to slightly increase or decrease the size of certain features to improve noise performance As such, the tread is comprised of multiple segments that may or may not be the same. While any quantity of segments may be arranged adjacently in the lengthwise direction of the tire to form the tire tread, by example, a tire tread may be formed of 20 to upwards of 80 segments. In certain other instances, in associating between lateral discontinuity thicknesses within the different regions within a specific range of longitudinal locations, the lateral discontinuities related by the different thicknesses are arranged to be concurrently arranged within a tire footprint during tire operation. A tire footprint is the area of contact between a tire, and more specifically, the tire tread and a ground surface. It is the outer, ground-engaging side of the tire tread that contacts the ground. In certain instances, the related lateral discontinuities are located in the direction of the tread length 0 to 20% of the footprint length, where the footprint length is measured in the direction of the tread length.

In comparing between the thicknesses of lateral discontinuities arranged in a shoulder rib (the “outermost rib”), in a center rib (the “centermost rib”), and, when present, an intermediate rib, it is appreciated that any such thickness may form any thickness measured along the depthwise extension of the lateral discontinuity and taken at any location along the length of the lateral discontinuity, or the thicknesses may be an average thickness determined for each such lateral discontinuity. In other instances, an average lateral discontinuity thickness may be determined for each rib, and the average lateral discontinuity thicknesses are relatively provided between shoulder, intermediate, and center ribs.

For example, in certain instances, the thickness of a lateral discontinuity taken at any location along the depthwise extension thereof in a shoulder rib is less than the width of a lateral discontinuity taken at any location along the depthwise extension thereof in a center rib, and when present, the thickness of a lateral discontinuity taken at any location along the depthwise extension thereof in an intermediate rib is less than the thickness of the lateral discontinuity in the center rib and greater than the thickness of the lateral discontinuity in the shoulder rib. For example, in certain instances, the lateral discontinuity thickness in the shoulder rib is 0.13 mm, the lateral discontinuity thickness in the intermediate rib is 0.4 mm, and the lateral discontinuity thickness in the center rib is 0.6 mm. In a more general example, the thickness of at least one lateral discontinuity in each shoulder rib is 0 to 0.3 mm and the thickness of at least one lateral discontinuity in each center rib is 0.3 to 0.8 mm or more in other variations. In another example, the thickness of at least one lateral discontinuity in each shoulder rib is 0 to 0.2 mm, the thickness of at least one lateral discontinuity in any center rib is 0.2 to 0.4 mm or 0.4 to 0.8 mm, and the thickness of at least one lateral discontinuity in any intermediate rib is 0.4 to 0.8 mm or more in other variations. It is appreciated that the relative association between lateral discontinuities in different ribs and the thicknesses thereof may be made by relating lateral discontinuities located at the same or different longitudinal locations around the tire. In certain instances, the lateral discontinuities in different ribs whose thicknesses are being related are located at the same longitudinal location of the tire tread, where at the longitudinal location, which extends across the tread width, a corresponding lateral discontinuity located in a shoulder and central rib, and when present, in an intermediate rib, are associated and characterized as having the relative thickness associations described herein. In lieu of requiring association based upon a specific longitudinal location, association between lateral discontinuity thicknesses within the different ribs may occur within a specific range of longitudinal locations In particular instances, this is accomplished within a segment of the tire tread, as described previously above. In certain other instances in associating between lateral discontinuity thicknesses within the different ribs within a specific range of longitudinal locations, the lateral discontinuities related by the different thicknesses are arranged to be concurrently arranged within a tire footprint during tire operation, as described previously.

When relating the thicknesses of different lateral discontinuities as contemplated herein, in particular instances, this is done at a particular depth of the tread thickness. Accordingly, this depth may be located at a zero depth, that is, at the outer, ground engaging side of the tread, or at any depth below the outer, ground-engaging side.

In determining an average thickness for any lateral discontinuity, the average thickness is an average thickness as determined at any particular depth of the lateral discontinuity, where the average thickness is determined along the length of a subject lateral discontinuity. It is appreciated that the average may be determined according to any desired method. For example, in particular instances, when either or both the opposing faces extend in any direction along non-linear paths, linear regression may be employed to convert the non-linear path of any corresponding face to an associated linear path. When doing so, the average thickness for any non-linear path is determined using the associated linear path. Of course, other techniques may be employed when any face of the pair of opposing faces forming the lateral discontinuity thickness is characterized as extending in any direction along a non-linear path, such as using differential equations or other known techniques, including use of any modeling or analytical software program. In other instances, when determining an average thickness for any lateral discontinuity, the average thickness is not quantified as an average taken at a particular depth of the tread thickness, but rather an average taken for over the full depth of the tread element. This may be accomplished using any of a variety of known techniques.

Exemplary embodiments of the tire treads discussed above will now be described in association with the figures.

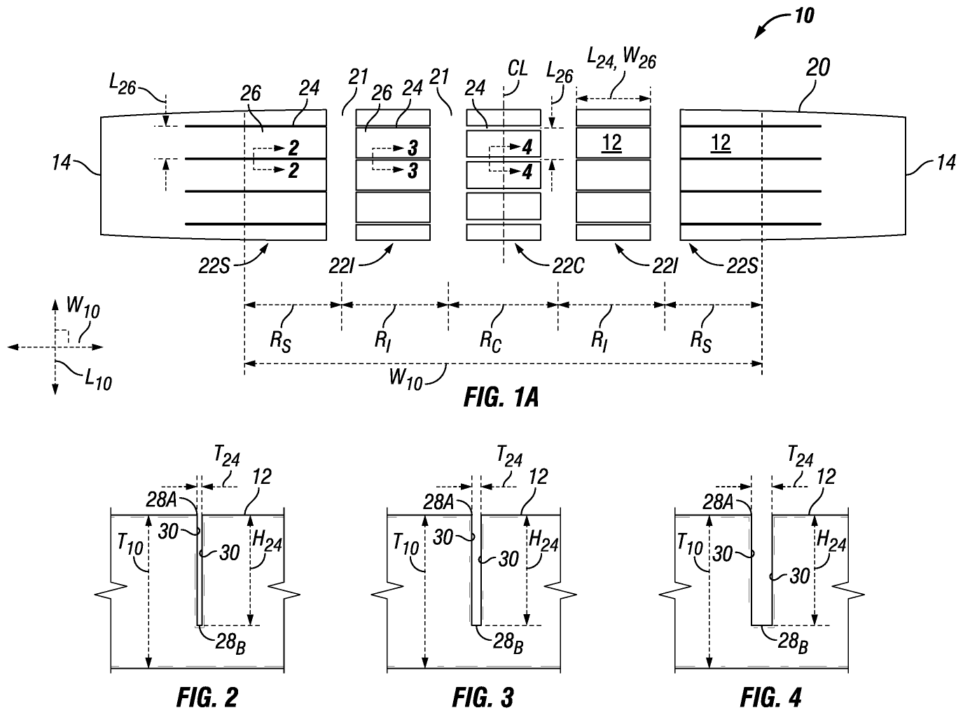

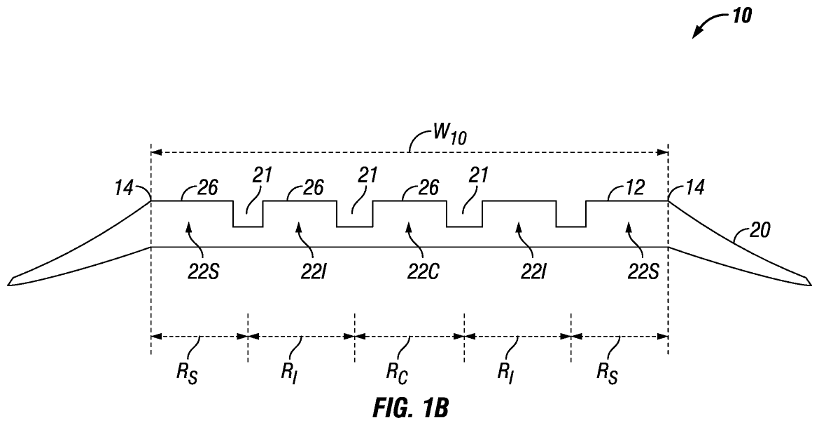

In an exemplary embodiment shown in FIG. 1A, improvements over prior art tire treads are shown, where in the exemplary tread 10, the thickness T₂₄ of the lateral discontinuities 24 in the shoulder ribs 22S are less than those in the center rib 22C and intermediate ribs 22I. Further, the thickness T₂₄ of the lateral discontinuities 24 in the intermediate ribs 22I are less than those in the center rib 22C. More generally with regard to the tread 10 in the exemplary embodiment, a segment 20 of the exemplary tread 10 is shown, the segment 20 forming a portion of the tread where the segment extends longitudinally for only a portion of the tread length L₁₀ and across the tread width W₁₀ between opposing lateral sides 14. Tread width W₁₀ is the width of the tread associated with the outer, ground-engaging side 12, and not necessarily the full tread width, which may or may not extend down towards the tire sidewall. The tread 10 and tread segment 20 each include a plurality of widthwise regions of the tread, namely, a pair of shoulder regions R_{S} arranged at the outermost extend of tread width W₁₀, a center region R_{C} arranged closest to the tread centerline CL, and intermediate regions R_{I} each arranged between the center region R_{C} and one of the shoulder regions R_{S}. Each region R_{S}, R_{C}, R_{I} includes a portion of the plurality tread elements 26 and a portion of the plurality of lateral discontinuities 24. It is evident that the thickness T₂₄ of lateral discontinuities 24 in the shoulder regions R_{S} are less than those in the center region R_{C} and intermediate regions R_{I}, while the thickness T₂₄ of the lateral discontinuities 24 in the intermediate region R_{I} are less than those in the center region R_{C}. In the embodiment shown, each partition between adjacent regions is arranged along longitudinal grooves 21, but it is appreciated that in other instances, it is not necessary to align these partitions at or within longitudinal grooves as the partitions may be arranged at any desired location across the tread width. The tread 10 and the tread segment 20 also include a plurality of ribs 22S, 22I, 22C, separated by a longitudinal groove 21. In this instance, each shoulder rib 22S is arranged in one of the shoulder regions R_{S}, center rib 22C is arranged in center region R_{C}, and each intermediate rib 22_{I} is arranged in one of the intermediate regions R_{I}. Each rib includes a plurality of lateral discontinuities 24 spaced apart in the longitudinal direction of the tread (direction of tread length L₁₀) to define tread elements (tread blocks) 26 in each rib. Each tread element 26 has a length L₂₆ measured in the direction of the tread length L₁₀. In the exemplary embodiment shown all tread elements 26 in each of the ribs 22S, 22I, 22C have equal lengths L₂₆; however, in other variations, the tread element lengths may vary within a rib and/or between ribs as desired. For example, in certain variations, tread element lengths L₂₆ increase from rib-to-rib, or from region-to-region between each shoulder rib/region and any center rib/region. In certain exemplary instances, tread element lengths L₂₆ increase from tread elements 26 arranged in shoulder regions R_{S} or shoulder ribs 22S to tread elements 26 arranged in intermediate regions R_{I} or intermediate ribs 22I and yet further increase to tread elements 26 arranged in center region R_{C} or center ribs 22C. It is also noted that each lateral discontinuity 24 has a length L₂₄. In the embodiment shown, each length L₂₄ extends linearly in the direction of the tread width W₁₀ (that is laterally, perpendicular to the direction of both the tread length L₁₀ and thickness T₁₀); however, in other variations, each may extend at an angle biased to the direction of the tread width and/or may extend along a non-linear path. In the embodiment shown, the lateral discontinuities in the shoulder regions R_{S} and shoulder ribs 22R are sipes, while the lateral discontinuities in the other ribs and regions are either sipes or grooves.

With reference to the view shown in FIG. 2B, the lateral profile of the tire tread of FIG. 2A is shown, where the tread width W₁₀ extends between the pair of opposing lateral sides 14 of the tread 10, the width forming a widthwise extent of the outer, ground-engaging side 12 of the tread 10. Tread width W₁₀ extends along a lateral profile until reaching each lateral side 14, at which point the tread 10 begins to extend down towards each opposing sidewall of the tire. Therefore, when referencing the tread width W₁₀, as noted previously, unless specifically noted otherwise, the tread width W₁₀ references the widthwise extent of the outer, ground-engaging side 12 and not necessarily the full widthwise extend of the tread material, which may or may not extend beyond the lateral profile of the outer, ground-engaging side and down the sidewalls of the tire.

With reference to FIGS. 2-4, the thicknesses of the lateral discontinuities are shown, which vary between regions and ribs. With reference to FIG. 2, a lateral discontinuity 24 of a shoulder rib 22S is shown, the lateral discontinuity 24 extending depthwise into the tread thickness T₁₀ from an outer, ground-engaging side 12 of the tread 10, the lateral discontinuity 24 extending from a first terminal end 28A and to a second terminal end 28B within the tread thickness. The lateral discontinuity 24 has a thickness T₂₄ extending between opposing faces 30 of the tread. Thickness T₂₄ is measured perpendicular to the direction of depthwise extension of the lateral discontinuity 24, where the direction of depthwise extension, in this instance, extends in the direction of the tread thickness T₁₀ (that is, perpendicular to both the direction of the tread width and the direction of tread length).

With reference to FIG. 3, a lateral discontinuity 24 of an intermediate rib 22I is shown, the lateral discontinuity 24 extending depthwise into the tread thickness T₁₀ from an outer, ground-engaging side 12 of the tread 10, the lateral discontinuity 24 extending from a first terminal end 28A and to a second terminal end 28B within the tread thickness. The lateral discontinuity 24 has a thickness T₂₄ extending between opposing faces 30 of the tread. Thickness T₂₄ is measured perpendicular to the direction of depthwise extension of the lateral discontinuity 24, where the direction of depthwise extension, in this instance, extends in the direction of the tread thickness T₁₀ (that is, perpendicular to both the direction of the tread width and the direction of tread length). As can be seen relatively between FIGS. 2 and 3, the lateral discontinuity 24 of the shoulder rib in FIG. 2 has a narrower thickness T₂₄ than the lateral discontinuity 24 shown in the intermediate rib in FIG. 3.

With reference to FIG. 4, a lateral discontinuity 24 of a center rib 22C is shown, the lateral discontinuity 24 extending depthwise into the tread thickness T₁₀ from an outer, ground-engaging side 12 of the tread 10, the lateral discontinuity 24 extending from a first terminal end 28A and to a second terminal end 28B within the tread thickness. The lateral discontinuity 24 has a thickness T₂₄ extending between opposing faces 30 of the tread. Thickness T₂₄ is measured perpendicular to the direction of depthwise extension of the lateral discontinuity 24, where the direction of depthwise extension, in this instance, extends in the direction of the tread thickness T₁₀ (that is, perpendicular to both the direction of the tread width and the direction of tread length). As can be seen relatively between FIGS. 2 and 4, the lateral discontinuity 24 of the shoulder rib in FIG. 2 has a narrower thickness T₂₄ than the lateral discontinuity 24 shown in the center rib in FIG. 4. It can also be seen relatively between FIGS. 3 and 4 that the lateral discontinuity 24 of the intermediate rib in FIG. 3 has a narrower thickness T₂₄ than the lateral discontinuity 24 shown in the center rib in FIG. 4.

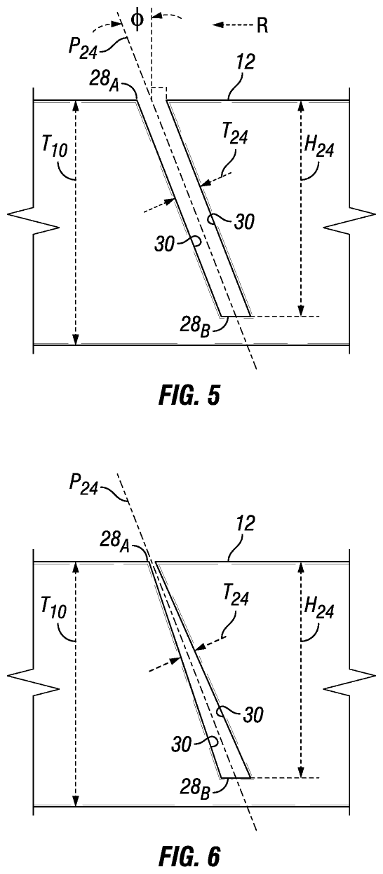

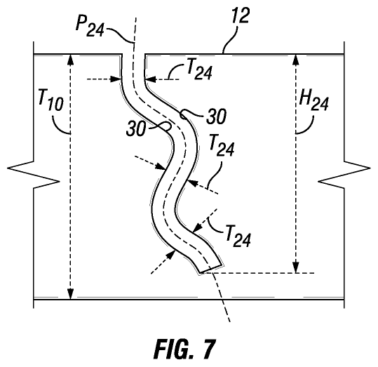

With reference now to another exemplary embodiment in FIG. 5, an exemplary lateral discontinuity 24 extends depthwise into the tread along a linear path P₂₄, where the depthwise extension is biased relative to the direction of the tread thickness T₁₀ by angle ϕ. In this embodiment, angle ϕ is positive, as it extends in the direction of intended tire rotation. Still, any positive or negative angle may be employed as desired. It is also noted that path P₂₄ extends through the depthwise extension midway across the thickness T₂₄ and between opposing faces (sides) 30, so to form a midline through the depth of the lateral discontinuity. In this embodiment, the thickness T₂₄ is constant along the depthwise extension, as opposing faces are also linear and equally spaced from the midline (path P₂₄). It is appreciated that this constant thickness is shown to occur at a particular location along the length of the lateral discontinuity (as the figure depicts a cross-section of the tread at a particular lengthwise location), and therefore, it is understood that the constant thickness may remain constant along the length of the lateral discontinuity or the thickness may vary as the lateral discontinuity extends to different locations along the length. Still, it is contemplated that the thickness of any lateral discontinuity may vary as a lateral discontinuity extends in any direction. In exemplary variations, with reference to FIG. 6, the thickness T₂₄ of a lateral discontinuity 24 is shown to vary along its depthwise extension within the tread thickness. The thickness T₂₄ generally varies linearly, as each of the opposing faces 30 extend linearly within the tread thickness. With reference now to FIG. 7, in another exemplary embodiment the thickness T₂₄ of a lateral discontinuity 24 is shown to extend depthwise along a non-linear path P₂₄. Both opposing faces 30 also extend along a non-linear path, and because the path each face 30 extends is not only non-linear, but is also spaced apart from the midline (the non-linear path P₂₄), the thickness T₂₄ remains constant through the depthwise extension. Multiple thickness references T₂₄ are shown at various locations along the depthwise extension of the lateral discontinuity to reinforce the notion that the thickness T₂₄ is to be measured in a direction perpendicular to the path P₂₄ at any location along the depthwise extension of the lateral discontinuity 24. Of course, in other variations, each face may be linear or non-linear, or any combination thereof, such that the lateral discontinuity thickness remains constant or variable.

FIGS. 5-7 have been provided to show how thicknesses of lateral discontinuities are to be measured. The same principles are to be employed when measuring the thickness in any other plane or direction, such as along the length of each lateral discontinuity. It is appreciated that when any lateral discontinuity is a sipe, and when one or more voids are arranged along the length and/or depth of said sipe, where any such void is thicker than the lateral discontinuity, any such void forms a separate feature and the lateral discontinuity thickness is considered separate from any such void for the purposes of determining the lateral discontinuity thickness. For example, with reference to FIG. 12, this may occur when a lateral sipe 24 is coupled to a submerged groove 42 to form a tear drop sipe or, with reference to FIG. 11, when a lateral sipe 24 is coupled to a plurality of grooves 40 extending depthwise into the tread thickness T₁₀ from the outer, ground-engaging side 12. In more specific instances where the lateral discontinuity is a sipe configured to close during tire operation, the presence of any separate but coupled groove feature is generally inconsequential. This is because the contact between opposing faces occurs. In more specific instances, where a separate but coupled void is present, the sipe provides a minimum contact surface area between the opposing faces that comprises at least 20% of each face of the combined sipe and groove. Accordingly, when determining the thickness of a lateral discontinuity, the thickness of any groove forming a distinct feature that is coupled to a sipe should be disregarded. This does not mean that a lateral discontinuity that forms a groove is not to be considered, as a lateral discontinuity may form a groove itself. What is meant is that if a lateral discontinuity includes any voids arranged along its length or depth, if the voids, in sum, do not consume more than 80% of the lateral discontinuity length or depth, or, as stated previously if 20% contact remains between the opposing faces forming the lateral discontinuity when the lateral discontinuity either closes during tire operation or when the sipe thickness is zero, all such voids are to be ignored when determining the lateral discontinuity thickness or average thickness. This is especially true when the lateral discontinuity is a sipe, but more broadly for any lateral discontinuity. Further, while in the figures all lateral discontinuities are shown to extend fully across a rib, it is appreciated that any such lateral discontinuity may extend partially across the width of a rib, and may or may not form a discontinuous lateral discontinuity that intermittently extends across the width of a rib.

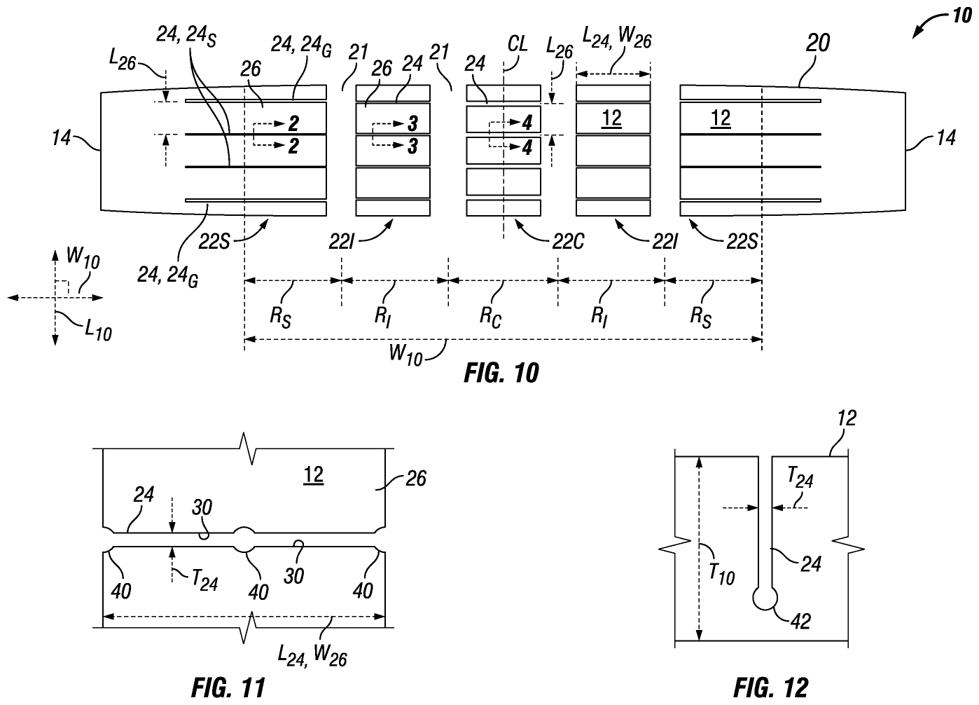

In similar fashion, it is appreciated that all lateral discontinuities in any region or rib can vary. For example, in FIG. 10, a variation of FIG. 1 is shown where lateral discontinuities 24 forming lateral grooves 24_{G} are shown arranged in shoulder region R_{S} and in shoulder ribs 22S, where the lateral grooves 24_{G} are spaced apart to form a larger block 26 containing a plurality of lateral discontinuities 24 forming sipes 24_{S}. In instances such as this, where a pair of lateral grooves are employed to form a larger block containing one or more lateral sipes, the lateral sipe thicknesses are compared to other lateral discontinuities in any other region or rib, which may or may not also be arranged within a larger block defined by a pair of opposing lateral grooves. In similar fashion, the lateral grooves may not be included when calculating an average lateral discontinuity thickness for any region or rib, meaning, the average thickness would focus on the lateral discontinuities arranged within any tread element formed between any pair of lateral grooves.

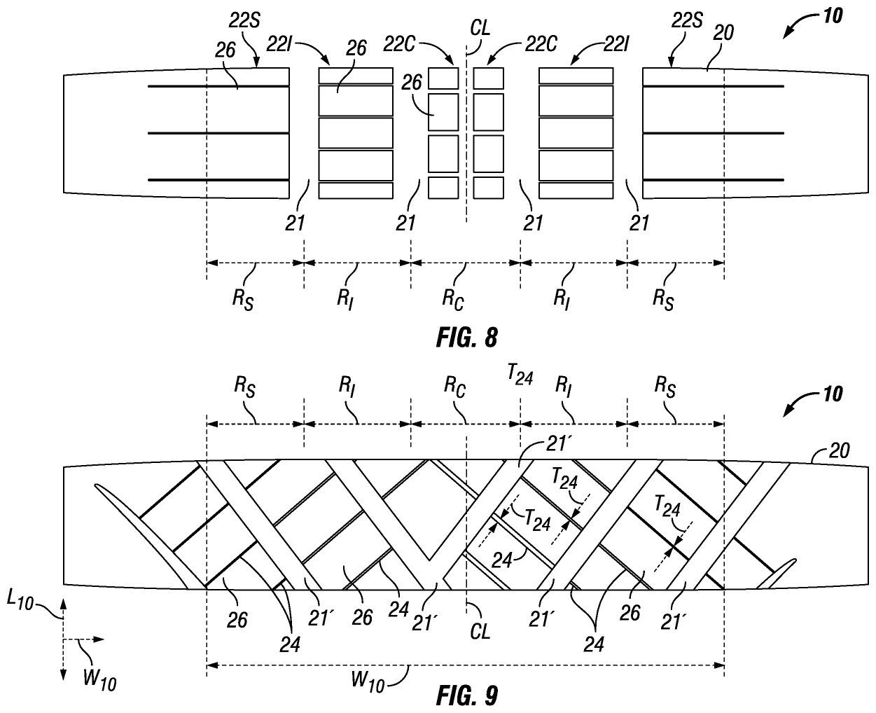

As noted previously, a tread may include any number of ribs, but at least a pair of shoulder ribs and a center rib. With reference to another exemplary tire tread in FIG. 8, a variation of the tread 10 of FIG. 1A is shown. In FIG. 8, a tire tread 10 having six (6) ribs is shown, which include shoulder ribs 22S and intermediate ribs 22I, but unlike the tread of FIG. 1A, which has a single center rib 22C, the tire tread 10 of FIG. 8 has a pair of center ribs 22C spaced apart by a longitudinal groove 21, each center rib 22C located on opposite sides of the centerline CL and spaced apart from the centerline CL It is appreciated that each center rib 22C may be spaced apart from the centerline CL by the same distance (such as is exemplarily shown) or by different distances, which would render the tire tread asymmetrical about centerline CL.

As noted previously, a tread may include a plurality of tread elements that are not arranged in a rib. In an exemplary embodiment shown in FIG. 9, a plurality of tread elements 26 are arranged along a segment 20 of a tread 10. The tread elements 26 are separated by lateral discontinuities 24 and longitudinal grooves 21′ that do not extend the full length L₁₀ of the tread. Therefore, each array of tread elements 26 arranged adjacent each longitudinal groove 21′ do not form a rib since the array of tread elements 26 does not extend the full length L₁₀ of the tread due to each corresponding longitudinal groove 21′ extending at an angle biased to the longitudinal direction L₁₀ of the tread. In this embodiment, instead of arranging lateral discontinuities 24 of different thicknesses T₂₄ as otherwise described herein between ribs, different lateral discontinuities thicknesses T₂₄ are arranged between shoulder regions R_{S}, a center region R_{C}, and intermediate regions R_{I}. Of course, in other variations, one or more ribs may be included in any tread while other tread elements outside any of the one or more ribs may be associated with a shoulder or center region, or, if present, an intermediate region.

By virtue of employing the inventive tread features described herein, which includes thinner sipes in the shoulder ribs versus intermediate and center ribs, a reduction in slip is achieved, which therefore reduces tread wear when a tire is operating under a driving torque, which may comprise an accelerating torque, for example. This reduction in slip is accomplished by reducing at the trailing edge the shear strain needed to achieve a desired longitudinal force with a tread element during tire operation. These improvements were realized with on-vehicle testing, where a test driver compared different tires each characterized as having either identical sipe thickness and tread element lengths (the reference) or progressively shorter tread element lengths from center to shoulder and progressively thinner sipes from center to shoulder (new design). Tread element lengths are measured in the circumferential direction of the tire between defining lateral discontinuities.

The tests were conducted on a front-wheel compact car on a wear circuit approximating typical driving conditions. The tires tested consisted of three (3) sets of tires each having different tread designs. Each of the three tire tread designs was a 5-rib design comprising a pair of shoulder ribs, a center rib, and an intermediate rib arranged between the center rib and each shoulder rib. The rib widths did not change between tread designs. Circumferential grooves of the same design, having the same width and depth, separated each of the 5 ribs in each tread design. Each rib was parsed into tread elements by a plurality of lateral discontinuities, each lateral discontinuity extending the full width of each tread element. All lateral discontinuities extended across each corresponding rib in a straight line entirely in the lateral direction of the tread, that is, in a direction perpendicular to the circumferential grooves. The depth of each lateral discontinuity did not change between tread designs. For each of the three different tires, the tire construction and inflation were also the same. The difference between the 3 different tread designs were reflected in different lateral discontinuity thicknesses and/or different tread element lengths in certain ribs. In the first design, all tread elements within each rib and within all ribs had the same tread element length and the same lateral discontinuity thickness. In particular, each lateral discontinuity in the tread had a constant 0.8 mm thickness. The second design maintained the same tread element lengths and as the first design (the reference), but all lateral discontinuities in each shoulder rib had a constant zero thickness (0 mm) and all lateral discontinuities in each intermediate rib has a constant thickness of 0.4 mm. All lateral discontinuities in the center rib remained 0.8 mm in thickness. As for the third tread design, the same lateral discontinuity thickness for each of the ribs employed in the second tread design were also employed in the third tread design, however, for the third tread design, shorter length tread elements were employed in each shoulder rib while longer tread element lengths were employed in the center rib. The tread element lengths remained the same in the third tread design relative to both the first and second tread designs.

Upon comparing the front tires from each test, the tires utilizing each of the second and third tread designs surprisingly achieved at least a 37% wear improvement over the tires employing the first tread design (the reference). In particular, the second tread design achieved a 37% wear improvement while the third design achieved a 49% improvement. It is further noted that the wear profile between ribs in the second tread design resembled the wear profile between ribs of the first tread design (the reference), where in each case the wear profile was relatively symmetric with the centermost region experiencing the highest wear rate. To the contrary, the wear profile of the third tread design was more uniform across all ribs, where the wear rate of the centermost region was more akin to the wear rates observed by the outermost regions. This was a surprising result when employing longer tread elements in the center rib of the tread, as one would have expected to observe a higher wear rate in the centermost region. It is also noted that for the third design, heel and toe wear was not problematic and this was surprising since it was otherwise expected to be problematic. These improvements with the third design were also surprising since other tests conducted with a tire tread characterized as having the increasing element lengths from the shoulder to the center as provided in the third design but with lateral discontinuities of constant thickness from rib to rib did not present favorable results, and it was expected that unfavorable results would arise when comparing the second and third tread designs.

To the extent used, the terms “comprising,” “including,” and “having,” or any variation thereof, as used in the claims and/or specification herein, shall be considered as indicating an open group that may include other elements not specified. The terms “a,” “an,” and the singular forms of words shall be taken to include the plural form of the same words, such that the terms mean that one or more of something is provided. The terms “at least one” and “one or more” are used interchangeably. The term “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (i.e., not required) feature of the embodiments. Ranges that are described as being “between a and b” are inclusive of the values for “a” and “b” unless otherwise specified.

While various improvements have been described herein with reference to particular embodiments thereof, it shall be understood that such description is by way of illustration only and should not be construed as limiting the scope of any claimed invention. Accordingly, the scope and content of any claimed invention is to be defined only by the terms of the following claims, in the present form or as amended during prosecution or pursued in any continuation application. Furthermore, it is understood that the features of any specific embodiment discussed herein may be combined with one or more features of any one or more embodiments otherwise discussed or contemplated herein unless otherwise stated.

1. A tire tread comprising:
a tread length extending in a longitudinal direction, a tread width extending in a lateral direction, a tread thickness extending in a depthwise direction from an outer, ground-engaging side of the tread, each of the longitudinal direction, the lateral direction, and the depthwise direction being perpendicular to one another,
the tread width extending between a pair of opposing sides of the tread each arranged at a widthwise extent of the outer, ground-engaging side, and a longitudinal centerline extending in the tread length in the longitudinal direction midway across the tread width,
a plurality of tread elements and a plurality of lateral discontinuities arranged along the tread width and tread length, each of the plurality of tread elements being spaced apart by one of the plurality of lateral discontinuities;
where the tread width is divided into a plurality of regions, the plurality of regions including: (1) a pair of outermost regions, each outermost region being arranged closest to one of the pair of opposing sides of the tread, (2) at least one centermost region arranged closest to the longitudinal centerline of the tread, and (3) at least one intermediate region arranged between the centermost region and at least one of the pair of outermost regions,
where each of the lateral discontinuities have a thickness, the thickness being defined by opposing faces of the tire tread, each opposing face extending laterally and depthwise into the tread thickness with each corresponding lateral discontinuity, where for the plurality of lateral discontinuities, the thickness of one or more of the lateral discontinuities arranged in each region of the pair of outermost regions is smaller than the thickness of one or more of the lateral discontinuities arranged in the centermost region,
where each of the lateral discontinuities in the outermost regions is a sipe, where the thickness of each of the lateral discontinuities arranged in each of the outermost regions is less than the thickness of the lateral discontinuities arranged in the centermost region, and where the thickness of each of the lateral discontinuities arranged in the intermediate region is greater than the thickness of the lateral discontinuities arranged in each of the outermost regions but less than the thickness of the lateral discontinuities arranged in the centermost region.

2. The tire tread of claim 1, where the thickness of the lateral discontinuities in each of the pair of outermost regions is 0 to 0.2 mm.

3. The tire tread of claim 1, where the tire tread includes a plurality of ribs extending in the longitudinal direction of the tire tread, where a portion of the plurality of tread elements are arranged side-by-side in the longitudinal direction of the tread in each rib of the plurality of ribs,
where the plurality of ribs includes a pair of outermost ribs, each rib of the pair of outermost ribs arranged closest to one of the pair of opposing lateral sides of the tread of the plurality of ribs, and at least one centermost rib arranged closest to the longitudinal centerline of the tread of the plurality of ribs,
where one rib of the pair of outermost ribs is arranged in one of the pair of outermost regions and the other rib of the pair of outermost ribs is arranged in the other of the pair of outermost ribs, and where the centermost rib is arranged in the centermost region.

4. The tire tread of claim 3, where the thickness of the lateral discontinuities in each of the pair of outermost ribs is 0 to 0.2 mm.

5. (canceled)

6. The tire tread of claim 1 further comprising:
one or more intermediate ribs arranged between at least one centermost rib and the pair of outermost ribs, each of the one or more intermediate ribs being arranged in the intermediate portion.

7. The tire tread of claim 1, where each of the lateral discontinuities forms a sipe or a groove.

8. The tire tread of claim 1, where each of the plurality of lateral discontinuities forms a sipe.

9. The tire tread of claim 8, where the thickness for each sipe is configured to articulate between an open configuration and a closed configuration as the tire rotates during tire operation.

10. The tire tread of claim 1, where each of the lateral discontinuities extend into the tread from the outer, ground-engaging side of the tread.

11. The tire tread of claim 1, where the at least one lateral discontinuity arranged in each of the pair of outermost regions having the thickness that is smaller than the at least one lateral discontinuity arranged in the centermost region is arranged within a segment of the tread, the segment of the tread extending the width of the tread and partially in the longitudinal direction of the tread.

12. The tire tread of claim 1, where at least one of the tread elements arranged in the at least one centermost region has a length greater than a length of at least one of the tread elements arranged in the pair of outermost regions, at least one of the tread elements in the at least one centermost region and at least one of the tread elements in the pair of outermost regions being arranged to be within a tire footprint concurrently during tire operation.

13. The tire tread of claim 1, where the at least one lateral discontinuity arranged in each of the pair of outermost regions having the thickness that is smaller than the at least one lateral discontinuity arranged in the centermost region is arranged at the same lengthwise location along the tread length.

14. The tire tread of claim 1, where an average thickness of the lateral discontinuities arranged in each of the pair of outermost regions is smaller than an average thickness of the lateral discontinuities arranged in the centermost region.

15. The tire tread of claim 1, where an average thickness of the lateral discontinuities arranged in the pair of outermost regions is smaller than an average thickness of the lateral discontinuities arranged in the one or more intermediate regions, and where the average thickness of the lateral discontinuities in the one or more intermediate regions is smaller than the average thickness of the lateral discontinuities arranged in each of the at least one centermost region.

16. The tire tread of claim 1, where an average thickness of the lateral discontinuities arranged in the pair of outermost ribs is smaller than an average thickness of the lateral discontinuities arranged in the at least one centermost rib.

17. The tire tread of claim 16, further comprising one or more intermediate ribs arranged between at least one centermost rib and the pair of outermost ribs, each of the one or more intermediate ribs being arranged in an intermediate portion arranged between the centermost region and at least one of the pair of outermost regions, where the average thickness of the lateral discontinuities arranged in the pair of outermost ribs is smaller than an average thickness of the lateral discontinuities arranged in each of the one or more intermediate ribs, and where the average thickness of the lateral discontinuities in the one or more intermediate ribs is smaller than the average thickness of the lateral discontinuities arranged in each of the at least one centermost rib.

18. The tire tread of claim 1, where the thickness for any one or more of the plurality of lateral discontinuities is variable.
